(19) United States
(12) Patent Application Publication
(10) Pub. No.: US 2024/0329826 A1
(43) Pub. Date: Oct. 3, 2024

(54) OBJECT POSITION DETECTION APPARATUS AND DISPLAY METHOD USING THE SAME

(71) Applicant: HYUNDAI MOBIS CO., LTD., Seoul (KR)

(72) Inventors: Jun Seong SEO, Yongin-si (KR); Sung Hyun PARK, Hwaseong-si (KR); Hyang Sook KIM, Seongnam-si (KR); Ji Eun HWANG, Suwon-si (KR)

(73) Assignee: HYUNDAI MOBIS CO., LTD., Seoul (KR)

(21) Appl. No.: 18/519,328

(22) Filed: Nov. 27, 2023

(30) Foreign Application Priority Data
Mar. 31, 2023 (KR) 10-2023-0042604

(51) Int. Cl. G06F 3/0488; G06F 3/042; G06F 3/04817; G06F 3/0482

(52) U.S. Cl. CPC G06F 3/0488; G06F 3/0421; G06F 3/04817; G06F 3/0482

(57) ABSTRACT

A display method includes displaying at least one widget or menu icon to a length corresponding to a whole area or some areas of a display screen in one direction based on information about a size of the display screen, aligning the at least one widget or menu icon based on a manipulating position of an object or a detected position of the object, when the object approaches the display screen, and activating some of the at least one widget or menu icon based on the detected position of the object.

### CROSS-REFERENCE TO RELATED APPLICATION

This application claims priority from Korean Patent Application No. 10-2023-0042604, filed on Mar. 31, 2023, in the Korean Intellectual Property Office, the disclosure of which is incorporated herein by reference in its entirety.

### BACKGROUND OF THE INVENTION

### 1. Field of the Invention

The present invention relates to an object position detection technology, and more particularly, to a method and apparatus for displaying a menu screen which is dynamically changed depending on the detected position of an object.

### 2. Description of the Related Art

An optical sensor technology is a technology of tracking a direction or coordinates by emitting light from a light emitter and sensing light reflected back by a light receiver. Recently, a technology of sensing the position of an object by measuring a time taken to generate light and sense reflected light has been developed. A technology of displaying a pop-up menu in a region pointed with a user's finger by measuring the position of the user's finger adjacent to a display screen using the above technologies may be implemented.

However, in a general optical sensor, light from a light emitter is generally emitted in a vertical direction from the bottom to the top in front of a display. Therefore, it is possible to detect the relative position of the user's finger to a display screen in the state in which the user's finger is proximate to the display, but it is difficult to sense the position of the user's finger even when the user's finger is a little far from the display screen.

Further, in the conventional technologies, the manipulating position or entry area of a user's hand in a sensing area is not immediately reflected in the display screen, and thus, a user may not recognize that the position of his/her hand is being measured by an apparatus and may not quickly select a desired menu item.

Therefore, a technology, in which a user may operate menus even from a long distance without stretching out his/her hand toward a display screen, and the manipulating position and entry area of the user's hand may be immediately reflected in the display screen so that the user may rapidly recognize the position of his/her hand measured by an apparatus and may quickly select a desired menu item, is required in the technical field to which the present invention pertains.

The above information disclosed in the Background section is only for enhancement of understanding of the background of the invention and should not be interpreted as conventional technology that is already known to those skilled in the art.

### SUMMARY OF THE INVENTION

Therefore, the present invention has been made in view of the above problems, and it is an object of the present invention to provide a display method and apparatus in which a user may operate menus even from a long distance without stretching out his/her hand toward a display screen.

It is another object of the present invention to provide a display method and apparatus in which the manipulating position and entry area of a user's hand may be immediately reflected in a display screen.

It is yet another object of the present invention to provide a display method and apparatus in which a user may rapidly recognize the position of his/her finger measured by the apparatus, and may quickly select a desired menu item.

In accordance with an aspect of the present invention, the above and other objects can be accomplished by the provision of a display method using a position detection apparatus, including displaying, by a processor, at least one widget or menu icon to a length corresponding to at least a portion of an area of a display screen in one direction based on information about a size of the display screen, aligning, by the processor, the at least one widget or menu icon based on a manipulating position of an object or a detected position of the object, in response to the object approaching the display screen, and activating at least one of the at least one widget or menu icon based on the detected position of the object.

The display method may further include displaying, by the processor, detailed information corresponding to an activated menu icon on the display screen, in response to an approach distance of the object to the display screen being within a critical distance.

The display method may further include realigning, by the processor, the at least one widget based on the detected position of the object, in response to the object deviating from a region corresponding to a widget display range of the display screen.

The manipulating position of the object may be set in advance in a memory or a storage device, may be determined based on a position at which the object is first detected, or may be determined based on a stretching direction of the object or a shape of the object.

In the displaying of the at least one widget or menu icon, the at least one widget or menu icon may be displayed based on the size of the display screen and information about a screen mode, the size of the display screen may be one of sizes corresponding to a small-sized screen, a middle-sized screen, and a large-sized screen, and the screen mode may be one of a full screen mode or a split screen mode.

In accordance with another aspect of the present invention, there is provided a position detection apparatus including a display configured display information on a display screen, a linear infrared (IR) sensor configured to detect an object configured to approach the display, and a processor configured to: display at least one widget or menu icon to a length corresponding to at least a portion of an area of the display screen in one direction based on information about a size of the display screen, align the at least one widget or menu icon based on a manipulating position of an object or a detected position of the object, when the object approaches the display screen, and activate some of the at least one widget or menu icon based on the detected position of the object.

The processor may display detailed information corresponding to an activated menu icon on the display screen, when an approach distance of the object to the display screen is within a critical distance.

The processor may realign the at least one widget based on the detected position of the object, when the object deviates from a region corresponding to a widget display range of the display screen.

The manipulating position of the object may be set in advance in a memory or a storage device, may be determined based on a position at which the object is first detected, or may be determined based on a stretching direction of the object or a shape of the object.

The processor may display the at least one widget or menu icon based on the size of the display screen and information about a screen mode, the size of the display screen may be one of sizes corresponding to a small-sized screen, a middle-sized screen, and a large-sized screen; and the screen mode may be one of a full screen mode or a split screen mode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a position detection apparatus according to one embodiment of the present invention;

FIG. 2 is a view showing one example of a sensing area of a display of the position detection apparatus of FIG. 1;

FIG. 3 is a view showing a linear sensor module according to one embodiment of the present invention;

FIG. 4 is a block diagram showing the configuration of the position detection apparatus according to one embodiment of the present invention;

FIG. 5 is a view showing one example of a user interface (UI) screen which may be displayed on a display screen before the position of an object is detected in a position detection apparatus when a sensing field is divided into eight sections in a direction of a second axis;

FIGS. 6 to 9 are views showing one example of change in the UI screen depending on the manipulating position of a user's hand in the position detection apparatus when the sensing field divided is into the eight sections in the direction of the second axis;

FIGS. 10 to 12 are views showing examples of widget alignment methods depending on the manipulating position of the user's hand in the position detection apparatus when the sensing field is divided into the eight sections in the direction of the second axis;

FIG. 13 is a view showing one example of an arrangement relationship between a driver's seat and a screen of the position detection apparatus when the sensing field is divided into twelve sections in the direction of the second axis;

FIGS. 14A to 14D are views showing one example of a UI alignment method depending on the manipulating position of a user's hand in the position detection apparatus when the sensing field is divided into the twelve sections in the direction of the second axis;

FIGS. 15A to 15I are views showing one example of a UI alignment screen depending on a region, in which an object is first detected, in the position detection apparatus when the sensing field is divided into the eight sections in the direction of the second axis;

FIGS. 16A to 16G are views showing a UI alignment screen depending on a region, in which an object is first detected, in the position detection apparatus when the sensing field is divided into the twelve sections in the direction of the second axis, and one example of UI realignment when the object deviates from a region corresponding to a widget display range;

FIGS. 17A to 17D are views showing another example of the UI alignment method depending on the region, in which the object is first detected, in the position detection apparatus when the sensing field is divided into the twelve sections in the direction of the second axis;

FIGS. 18A to 18C are views showing yet another example of the UI alignment method depending on the region, in which the object is first detected, in the position detection apparatus when the sensing field is divided into the twelve sections in the direction of the second axis;

FIGS. 19A to 19D are views showing one example of a UI alignment method depending on a region, in which an object is first detected, in the position detection apparatus when the sensing field is divided into six sections in the direction of the second axis;

FIGS. 20A to 20B are views showing one example of a main screen a navigation screen appearing when a navigation widget is touched, which may be displayed on the display screen of the position detection apparatus according to one embodiment of the present invention;

FIG. 21 is a flowchart representing a display method using the position detection apparatus according to one embodiment of the present invention; and

FIG. 22 is a flowchart representing a display method using the position detection apparatus according to another embodiment of the present invention.

### DETAILED DESCRIPTION OF THE PREFERRED EMBODIMENTS

Hereinafter, reference will now be made in detail to exemplary embodiments of the present invention, examples of which are illustrated in the accompanying drawings. Wherever possible, the same reference numbers will be used throughout the drawings to refer to the same or like parts, and a redundant description thereof will be omitted. In the following description of the embodiments, suffixes, such as “module”, “part” and “unit”, are provided or used interchangeably merely in consideration of ease in statement of the specification, and do not have meanings or functions distinguished from one another. Further, in the following description of the embodiments of the present invention, a detailed description of known functions and configurations incorporated herein will be omitted when it may make the subject matter of the present invention rather unclear. In addition, the accompanying drawings will be exemplarily given to describe the embodiments of the present invention, and should not be construed as being limited to the embodiments set forth herein, and it will be understood that the embodiments of the present invention are provided only to completely disclose the invention and cover modifications, equivalents or alternatives which come within the scope and technical range of the invention.

In the following description of the embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

As used herein, singular expressions may be intended to encompass plural expressions as well, unless the context clearly indicates otherwise.

In the following description of the embodiments, the terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

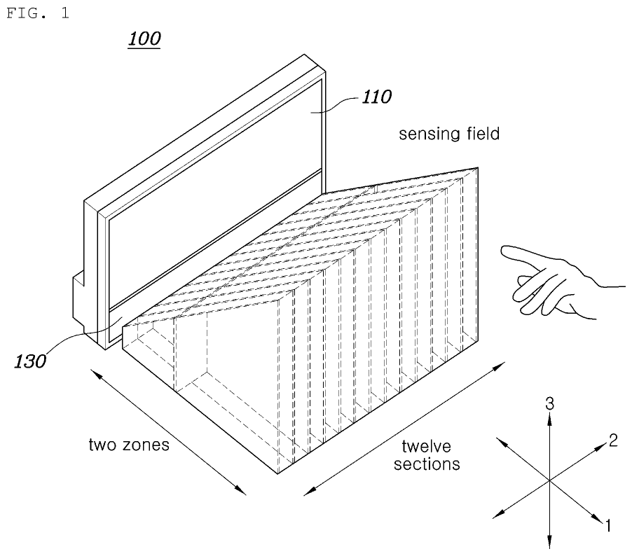

FIG. 1 is a view showing a position detection apparatus according to one embodiment of the present invention.

Referring to FIG. 1, a position detection apparatus 100 according to this embodiment may include a display 110 and a sensor 130.

The display 110 displays information on a screen.

For example, the display 110 may have a rectangular display area having a major axis direction extending in a direction of one axis (herein, a second axis) and a minor axis direction extending in a direction of another axis (herein, a third axis) intersecting the axis, and this shape of the display area is exemplary without being limited thereto. For example, the display area may have a polygonal, circular or oval shape, or a square shape having no distinction between the major axis and the minor axis thereof other than a rectangular shape, and the major axis direction and the minor axis direction may be reversed.

Further, the display 110 may be a display screen of an Audio, Video, and Navigation (AVN) system disposed between the driver's seat and the front passenger seat of a vehicle. For example, a multimedia reproducing screen, or a navigation screen configured to guide a driver to a path may be displayed, or a user interface configured to set various functions of the vehicle may be displayed on the display 110.

In addition, the display 110 may form an interlayered structure with touch sensors or be integrated with the touch sensors, thereby being capable of implementing a touchscreen. Such a touchscreen may function as a user input unit which provides an input interface for users, and may provide an output interface for users.

The display 110 may include at least one of a liquid crystal display (LCD), a thin-film-transistor liquid crystal display (TFT LCD), an organic light-emitting diode (OLED) display, a flexible display, a 3D display, or an e-ink display, without being limited thereto.

The sensor 130 extends in one direction (herein, the direction of the second axis) in which the display 110 extends, is disposed in parallel to the display 110, and senses whether or not an object approaching the display 110 is present, the position and movement of the object, and the like. The sensor 130 may be called a “linear sensor” due to the shape thereof.

The linear sensor 130 includes at least one light emitter arranged linearly, and a plurality of light receivers arranged linearly.

Here, the linear sensor 130 may sense an object (assuming hereinafter that the object to be sensed is a finger, for convenience of explanation) approaching the display 110 using a principle that, when the object approaches the display 110 located on the linear sensor 130, light (for example, infrared light) emitted from the light emitter is reflected by the finger, and the reflected light is detected by the light receivers.

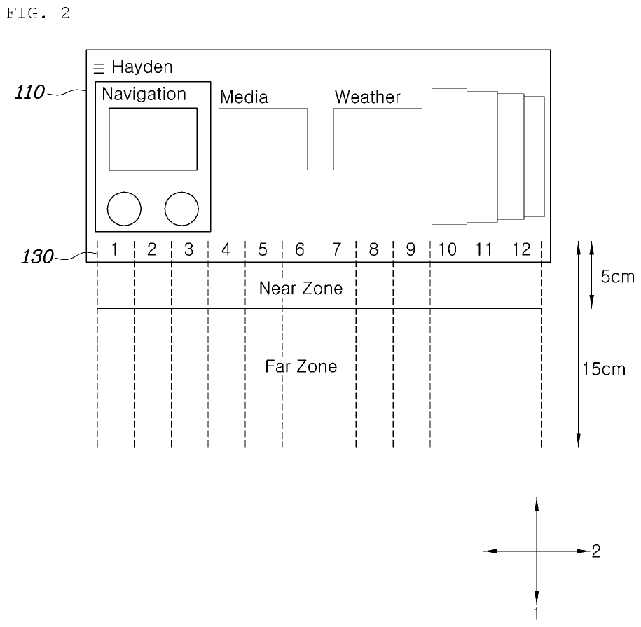

The detailed arrangement form of the light emitter and the light receivers will be described below with reference to FIG. 3.

The linear sensor 130 may be provided to be separated from and spaced apart from the display 110, and may be disposed to come into contact with the lower end of the display 110, or may be embedded in the display 110, for example, may be integrated with the display 110 to be buried under the rear surface of a cover glass which covers the screen of the display 110.

The light emitter may be disposed so that the sensing area (i.e., the sensing field) of the linear sensor 130 is formed within a designated area in front of a screen of the display 110. That is, the light emitter may be disposed such that the direction of light emission from the light emitter includes at least a direction of a first axis. Further, when the light emission pattern of the light emitter is a pattern spread in a fan shape, the sensing field may expand in the direction of the third axis as the sensing field goes forwards from the screen of the display 110. That is, the sensing field may be divided into a plurality of zones depending on a distance range from the screen of the display 110 in the direction of the first axis, and may be divided into a plurality of sections in one extension direction of the display 110 (herein, the direction of the second axis). For example, the sensing field may be divided into two zones in the direction of the first axis, and may be divided into twelve sections in the direction of the second axis, without being limited thereto. Further, the size of the sensing field may be variously set depending on the intensity and the radiation angle of light emitted from the light emitter, the intensity of light received by the light receivers, the arrangement pattern of the light emitter and the light receivers, the numbers of the light emitter and the light receivers, and the like.

Compared to a general position detection apparatus in which a sensing field is provided in a direction perpendicular to a display screen, the position detection apparatus 100 according to one embodiment, in which the sensing field of the linear sensor 130 has a shape expanding as the sensing field goes forwards from the screen of the display 110, as described above, may sense not only a finger proximate to the display 110 but also a finger approaching the display 110 even from a relatively long distance.

FIG. 2 is a view showing one example of the sensing area of the display of the position detection apparatus of FIG. 1.

Referring to FIG. 2, the sensing area of the linear sensor 130 may include twelve sections provided in the direction of the second axis. The number of the sections of the sensing area may be variously changed depending on the configurations of the light emitter and the light receivers of the linear sensor 130, as described above.

The position detection apparatus 100 may sense which section a finger proximate to the display 110 belongs to, and may provide or transform a user interface through the display 110 so as to correspond to the sensed section (for example, pop-up of a detailed menu, display of information, and the like). For example, as shown in FIG. 2, the sensing area may include twelve sections, i.e., first to twelfth sections, from left to right in the direction of the second axis. Here, the position detection apparatus 100 may execute (or enlarge/activate/pop up) a navigation widget when the finger is located in any of the first to third sections, may execute a media widget when the finger is located in any of the fourth to sixth sections, and may execute a weather widget when the finger is located in any of the seventh to ninth sections.

Further, the position detection apparatus 100 may measure a degree of proximity of the finger to the linear sensor 130 based on the intensity of received light, and, for example, may divide the sensing area into two zones, i.e., may determine that the finger is in a near zone when the finger is proximate to the linear sensor 130 within 5 cm, and may determine that the finger is in a far zone when the finger is proximate to the linear sensor 130 within a range of 5 cm to 15 cm. Here, the position detection apparatus 100 may be configured to perform different operations when the finger is located in the near zone and when the finger is located in the far zone. For example, the position detection apparatus 100 may be set to provide visual effects, such as enlargement or color change, of a selected menu on the display screen when the finger is located in the far zone, and to execute the selected menu when the finger is located in the near zone.

Further, although not shown in the drawings, the position detection apparatus 100 may change a menu alignment state depending on a region in which the finger is first sensed. For example, the position detection apparatus 100 may bias menus to the left when the finger is first detected in the first section, and may bias the menus to the right when the finger is first detected in the twelfth section.

FIG. 3 is a view showing a linear sensor module according to one embodiment of the present invention.

Referring to FIG. 3, a linear sensor module 130 according to the present invention may be configured such that sensor arrays SA, each of which includes a light emitting device 131 and light receiving devices 133, are spaced apart from one another by a designated interval in one direction. For example, the sensor arrays SA may have an arrangement pattern in which the light emitting device 131 is disposed at the center and the light receiving devices 133 are disposed at both sides of the light emitting device 131, without being limited thereto.

The light emitting device 131 may emit light and, when the light emitted from the light emitting device 131 is reflected by an object and is incident upon the light receiving devices 133, the light receiving devices 133 may sense the reflected light. For this purpose, the light emitting device 131 may include a light emitting diode (LED), and the light receiving devices 133 may include photo-diodes (PDs). Particularly, the light emitting device 131 may be an IR LED which emits infrared light. In the case that the light emitting device 131 is an IR LED, visual discomfort felt by a user when the user sees the display 110 may be prevented in consideration of the direction of formation and the shape of the sensing field.

The position detection apparatus 100 may operate the light emitting devices 131 provided in the respective sensor arrays SA consecutively or simultaneously, or may operate only some light emitting devices 131 (for example, one light emitting device 131) at a certain point in time through a time division method. When the time division method is used, power for sensing may be saved, and optical interference due to simultaneous operation of adjacent light emitting devices 131 may be reduced.

The number of the sensor arrays SA may be the same as or different from the number of the sections of the sensing area. As one example, in the case that the sensing field is divided into twelve sections in the direction of the second axis, twelve sensor arrays SA may be used so that one sensor array SA corresponds to one section. As another example, as shown in FIG. 3, the emission area of each of the sensor arrays SA may overlap at least a part of the emission area of an adjacent sensor array SA, and a smaller number of sensor arrays SA than the number of the sections of the sensing field may be used. In this case, a larger number of sections of the sensing field than the number of the sensor arrays SA may be provided so that the sections of the sensing field comprehensively determine the relative intensities of light sensed by the respective light receiving devices 133 of the plurality of sensor arrays SA.

The number of the sections divided from the sensing field of the position detection apparatus 100 in the direction of the second axis may be different depending on the size of the display screen. For example, the sensing field may be divided into six sections when the display screen is a small-sized screen, may be divided into eight sections when the display screen is a middle-sized screen, and may be divided into twelve sections when the display screen is a large-sized screen.

FIG. 5 is a view showing one example of a user interface (UI) screen which may be displayed on the display screen before the position of an object is detected in a position detection apparatus when the sensing field is divided into eight sections in the direction of the second axis.

Referring to FIG. 5, in the position detection apparatus according to one embodiment of the present invention, a plurality of widgets in a deactivated state may be aligned on the center of the display screen before the position of an object is detected.

Here, the widgets in the deactivated state may be aligned so as to have the same size.

The embodiment shown in FIG. 5 shows three widgets on one screen, but this is only one example and various numbers of widgets may be aligned on the center of the display screen.

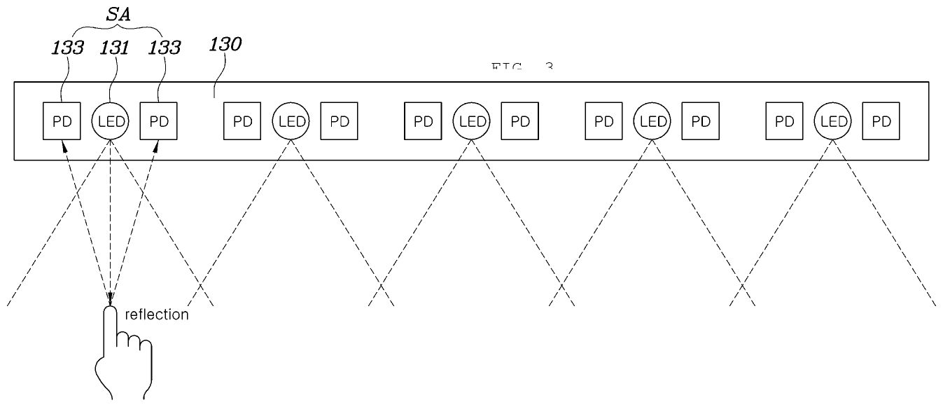

FIGS. 6 to 9 are views showing one example of change in the UI screen depending on the manipulating position of a user's hand in the position detection apparatus when the sensing field is divided into the eight sections in the direction of the second axis.

For example, as shown in FIGS. 6 to 9, the position detection apparatus may have the sensing area which is divided into two zones in the direction of the first axis and is divided into eight sections, i.e., first to eighth sections, from the left to the right in the direction of the second axis.

Referring to FIG. 6, when a user's finger is first recognized in the far zone in the direction of the first axis and in the first section in the direction of the second axis, the position detection apparatus may bias the widgets, which have been aligned on the center of the display screen, to the left, and may activate the navigation widget matching the first and second sections and a left icon matching the first section among icons in the navigation widget, when the widgets are aligned on the left of the display screen.

Here, the corresponding widget or icon may be activated in a way that the widget or the icon is enlarged, or has a different background color from other widgets or icons.

Further, referring to FIG. 7, when the user's finger is moved to the second section in the direction of the second axis in the state in which the user's finger remains in the far zone in the direction of the first axis, the position detection apparatus may deactivate the left icon, which has been previously activated, in the navigation widget, and activate a right icon matching the second section among the icons in the navigation widget, thereby visually displaying movement of the position of the user's finger to the second section.

Moreover, referring to FIG. 8, when the user's finger is moved to the third section in the direction of the second axis in the state in which the user's finger remains in the far zone in the direction of the first axis, the position detection apparatus may deactivate the navigation widget and the right icon, which have been previously activated, and may activate the media widget matching the third and fourth sections and an icon matching the third section among icons in the media widget, thereby visually displaying movement of the position of the user's finger to the third section.

Further, when the user's finger is moved to the near zone in the direction of the first axis, the position detection apparatus may display the details of a selected icon on the screen.

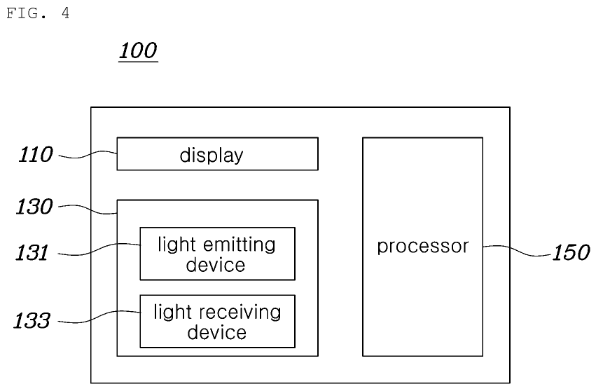

For example, referring to FIG. 9, when the user's finger is moved to the near zone in the direction of the first axis and the first section in the direction of the second axis, the position detection apparatus may deactivate the media widget and the icon, which have been previously activated, may activate the navigation widget matching the first and second sections, and may display the details of the left icon matching the first section among the icons in the navigation widget on the screen.

The display screen of the position detection apparatus may be installed between the driver's seat and the front passenger seat of the vehicle, and a user may operate the screen without stretching out his/her hand toward the display screen such that the widgets are aligned on the left of the screen when the user in the driver's seat operates the display screen, and the widgets are aligned on the right of the screen when the user in the front passenger seat operates the display screen.

FIGS. 10 to 12 are views showing examples of a widget alignment method depending on the manipulating position of a user's hand in the position detection apparatus when the sensing field is divided into the eight sections in the direction of the second axis.

FIG. 10 is a view showing one example of a UI alignment method when a user at the center of the vehicle operates the display screen of the position detection apparatus.

Here, the manipulating position of the user's hand may be set in advance in a memory or a storage device, or may be determined based on the position of a section of the sensing area in which the user's finger is first detected. Further, the manipulating position of the user's hand may be determined based on the stretching direction of the detected user's hand or the shape of the user's hand.

For example, referring to FIG. 10, when the user's finger is first recognized in any of the second to seventh sections, the position detection apparatus may determine that the user at the center of the vehicle operates the display screen, and may align the plurality of widgets on the center of the display screen.

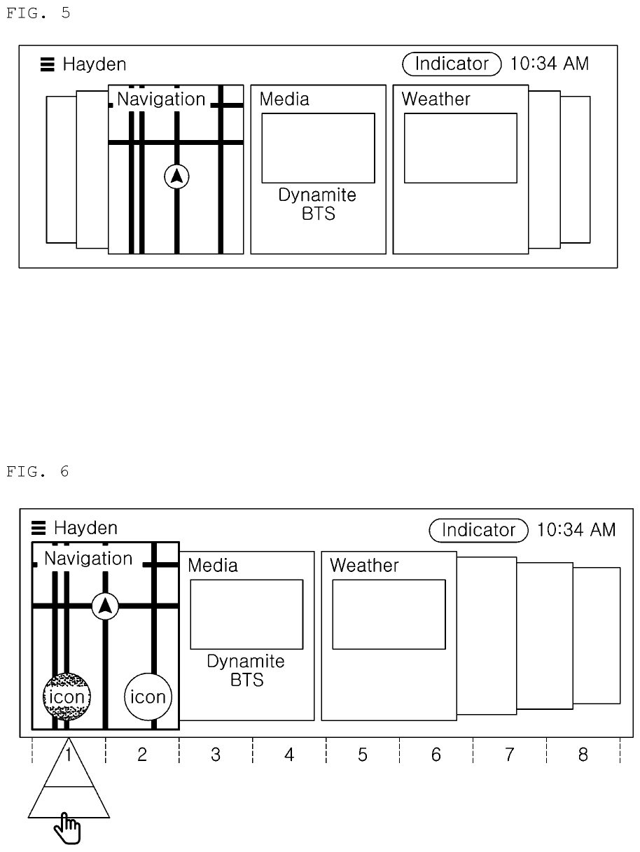

FIG. 11 is a view showing one example of the UI alignment method when a user in the driver's seat operates the display screen of the position detection apparatus.

Here, the position of the user's hand to operate the display screen of the position detection apparatus may be set in advance in the vehicle, or may be determined based on the position of a section in which the user's finger is first detected.

For example, referring to FIG. 11, when the user's finger is first recognized in the first section, the position detection apparatus may determine that the user in the driver's seat operates the display screen, and may align the plurality of widgets on the left of the display screen.

FIG. 12 is a view showing one example of the UI alignment method when a user in the front passenger seat operates the display screen of the position detection apparatus.

Here, the position of the user's hand to operate the display screen of the position detection apparatus may be set in advance in the vehicle, or may be determined based on the position of a section in which the user's finger is first detected.

For example, referring to FIG. 12, when the user's finger is first recognized in the eighth section, the position detection apparatus may determine that the user in the front passenger seat operates the display screen, and may align the plurality of widgets on the right of the display screen.

In the case that the display screen of the position is a large-sized screen and thus a driver in the driver's seat or a passenger in the front passenger seat of a vehicle has difficulty using the entire area of the display screen from the right end to the left end thereof, the widgets may be aligned on the display screen such that a user may operate all menu items using only a part of the display screen depending on the manipulating position of a user's finger on the display screen of the position detection apparatus.

For example, in the position detection apparatus when the sensing field is divided into twelve sections in the direction of the second axis, as shown in FIG. 13, a driver sitting in the driver's seat has difficulty stretching out his/her hand up to the right end of the display screen during driving, and thus, it is necessary to set the display screen such that the driver may operate the widgets using only some sections of the sensing area.

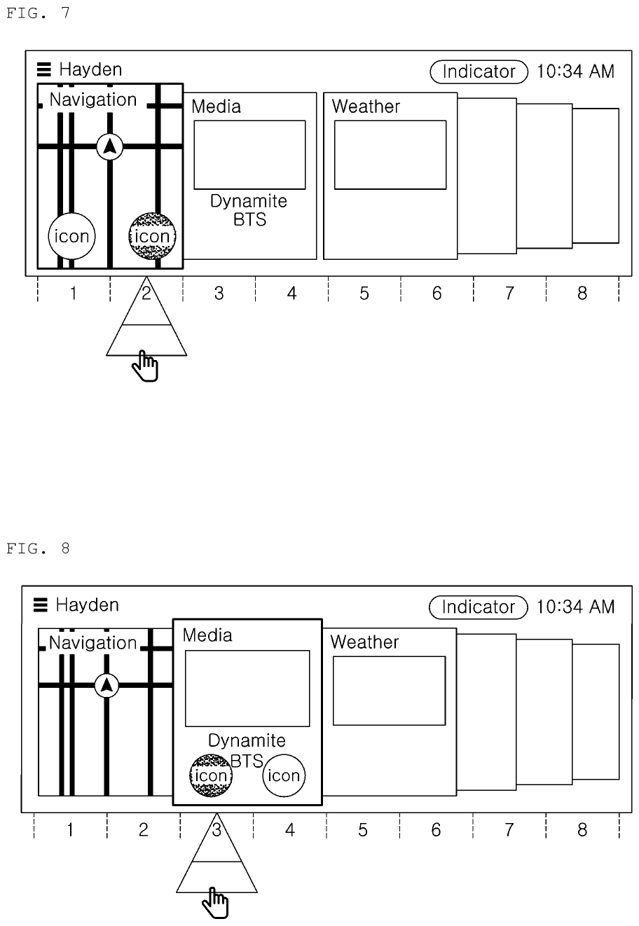

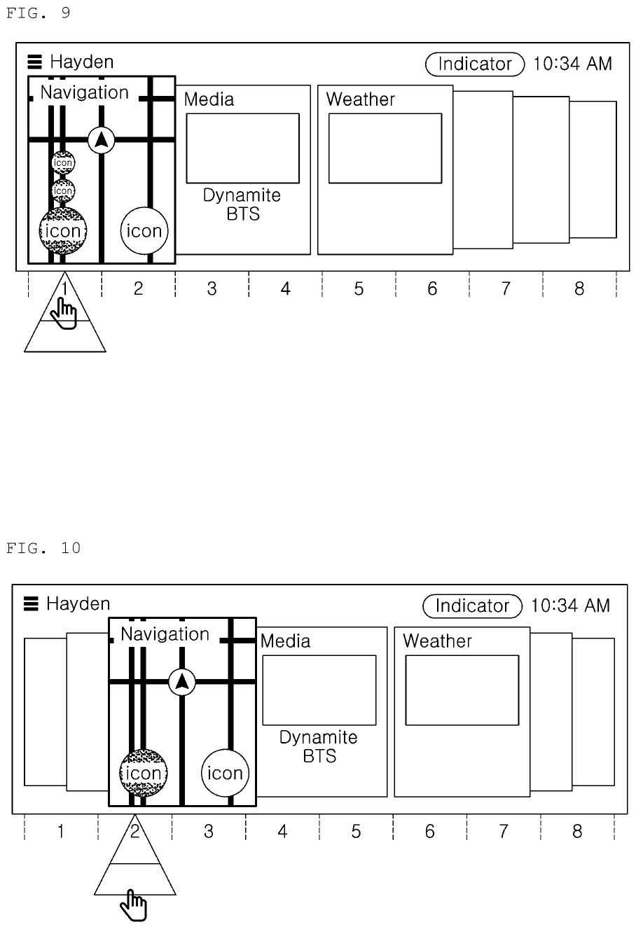

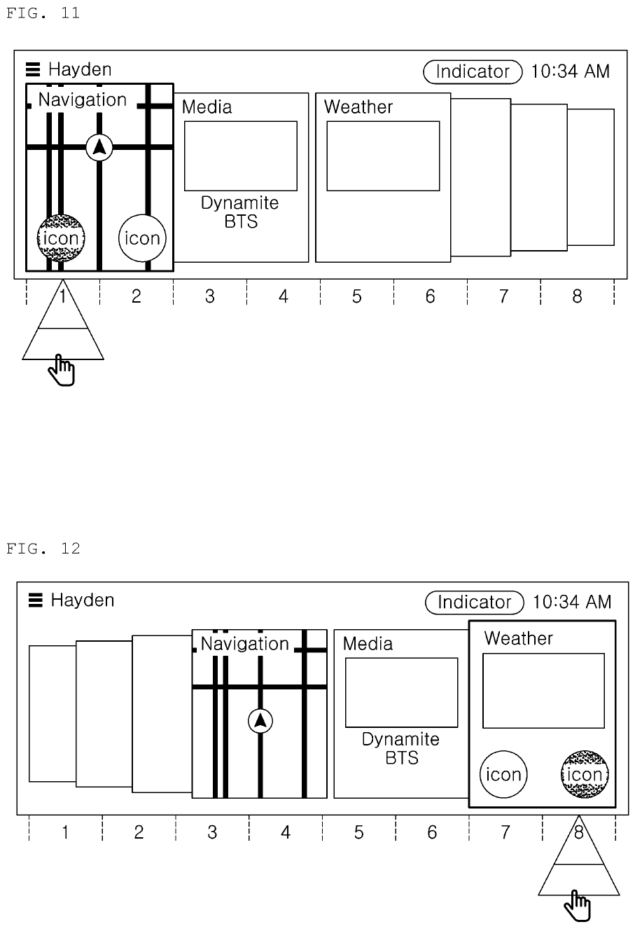

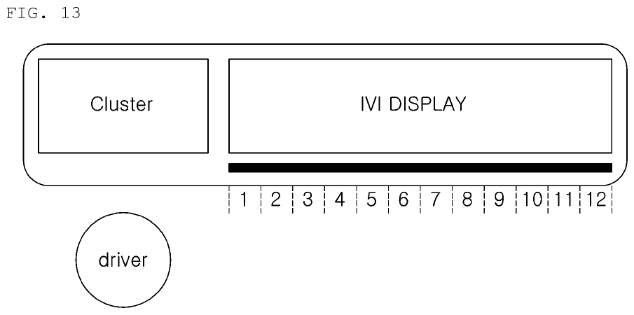

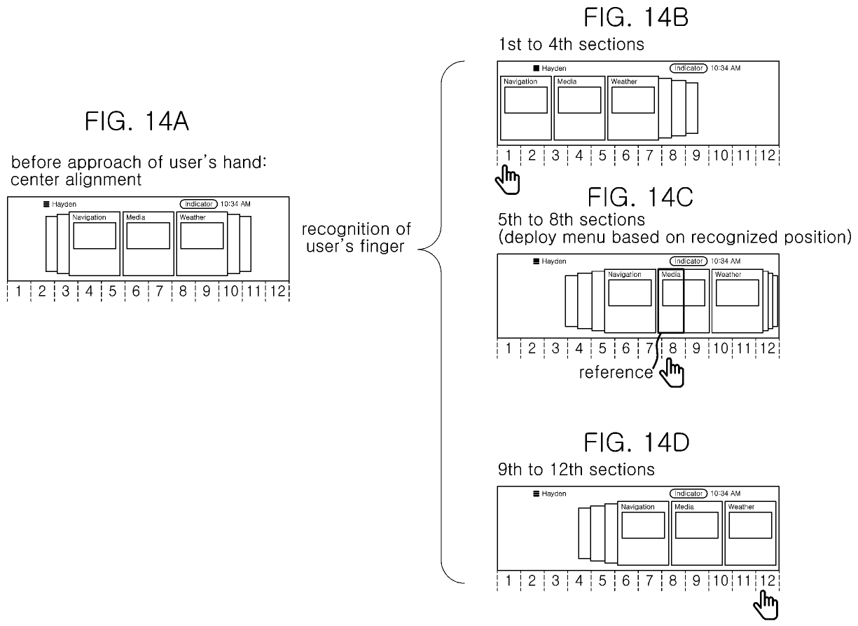

FIGS. 14A to 14D are views showing one example of a UI alignment method depending on the manipulating position of a user's hand in the position detection apparatus when the sensing field is divided into the twelve sections in the direction of the second axis.

Referring to FIGS. 14A to 14D, the position detection apparatus may align a plurality of widgets in the deactivated state on the center of the display screen before the position of an object is detected, and may then align the plurality of widgets on the display screen based on the position of a section in which a user's finger is first detected.

For example, when the user's finger is first detected in any of the first to fourth sections, the position detection apparatus may determine that the user in the driver's seat operates the display screen, and may align the widgets on the left of the display screen. Here, the widgets are aligned on the left region of the display screen corresponding to the first to sixth sections, and thus, the user may operate widget menus using only the first to sixth sections.

Further, when the user's finger is first detected in any of the fifth to eighth sections, the position detection apparatus may determine that the user at the center of the vehicle operates the display screen, and may align the widgets on the center of the display screen. Here, the widgets may be aligned on the display screen so that the central part of a widget located in the center among the plurality of widgets is located at a position in which the user's finger is first detected.

Here, when the widgets are provided in an even number or an even number of sections correspond to one widget, the widgets may be aligned on the display screen so that a region located at the left from the center of the alignment of the widgets is located at the position in which the user's finger is first detected.

For example, three widgets including the navigation widget, the media widget and the weather widget may be provided, and each of the respective widgets may have a width corresponding to the sum of the widths of two sections divided from the sensing field in the direction of the second axis. Here, when the user's finger is first detected in the eighth section, the widgets may be aligned on the display screen so that the right region of the media widget is located at a position corresponding to the eighth section.

Further, when the user's finger is first detected in any of the ninth to twelfth sections, the position detection apparatus may determine that the user in the front passenger seat operates the display screen, and may align the widgets on the right of the display screen. Here, the widgets are aligned on the right region of the display screen corresponding to the seventh to twelfth sections, and thus, the user may operate the widget menus using only the seventh to twelfth sections.

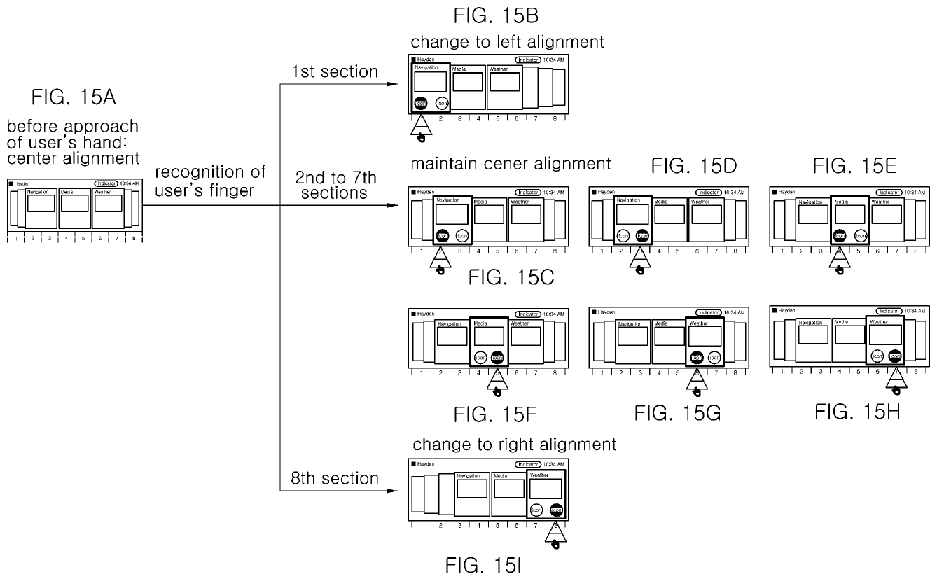

FIGS. 15A to 15I are views showing one example of a UI alignment screen depending on a region, in which an object is first detected, in the position detection apparatus when the sensing field is divided into the eight sections in the direction of the second axis.

Referring to FIGS. 15A to 15I, when a user's finger is first detected in the far zone in the direction of the first axis and in the first section in the direction of the second axis, the position detection apparatus may align widgets, which have been aligned on the center of the display screen, on the left of the display screen, and may activate the navigation widget matching the first and second sections and the left icon matching the first section among icons in the navigation widget, when the widgets are aligned on the left of the display screen.

Here, the corresponding widget or icon may be activated in a way that the widget or the icon is enlarged, or has a different background color from other widgets or icons.

Further, when the user's finger is first detected in the far zone in the direction of the first axis and in any of the second to seventh sections in the direction of the second axis, the position detection apparatus may activate a widget and an icon matching the position of the user's finger while maintaining the alignment of the widget on the center of the display screen.

For example, when the user's finger is first detected in the second section, the position detection apparatus may activate the navigation widget and the left icon matching the second section among the icons in the navigation widget.

Further, when the user's finger is first detected in the third section, the position detection apparatus may activate the navigation widget and the right icon matching the third section among the icons in the navigation widget.

Further, when the user's finger is first detected in the fourth section, the position detection apparatus may activate the media widget and the left icon matching the fourth section among the icons in the media widget.

Further, when the user's finger is first detected in the fifth section, the position detection apparatus may activate the media widget and the right icon matching the fifth section among the icons in the media widget.

Further, when the user's finger is first detected in the sixth section, the position detection apparatus may activate the weather widget and the left icon matching the sixth section among the icons in the weather widget.

Further, when the user's finger is first detected in the seventh section, the position detection apparatus may activate the weather widget and the right icon matching the seventh section among the icons in the weather widget.

When the user's finger is first detected in the far zone in the direction of the first axis and in the eighth section in the direction of the second axis, the position detection apparatus may align the widgets, which have been aligned on the center of the display screen, on the right of the display screen, and may activate the weather widget matching the seventh and eighth sections and the right icon matching the eighth section among the icons in the weather widget, when the widgets are aligned on the right of the display screen.

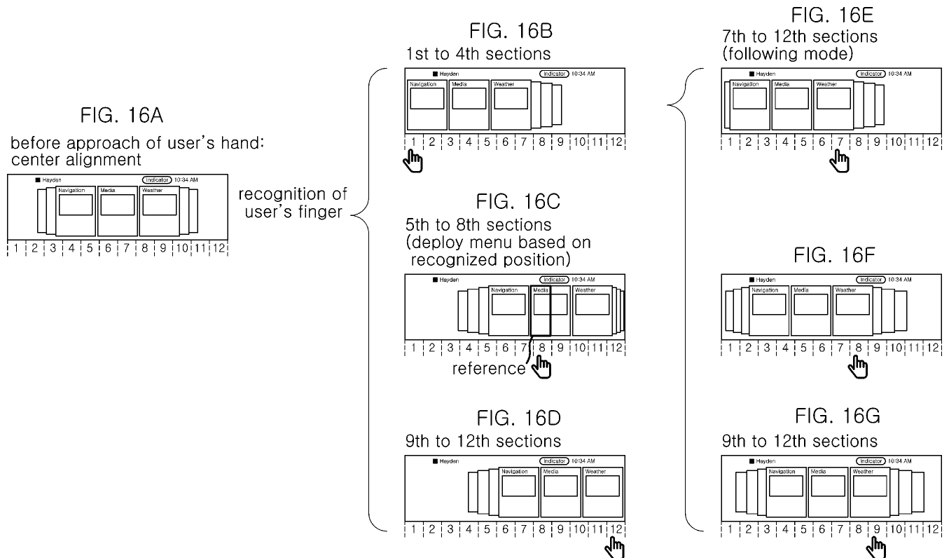

FIGS. 16A to 16G are views showing a UI alignment screen depending on a region, in which an object is first detected, in the position detection apparatus when the sensing field is divided into the twelve sections in the direction of the second axis, and one example of UI realignment when the object deviates from a region corresponding to a widget display range.

Referring to FIGS. 16A to 16G, when a user's finger is first detected in any of the first to fourth sections, the position detection apparatus may align a plurality of widgets on the left of the display screen. Here, the widgets are aligned on the left region of the display screen corresponding to the first to sixth sections, and thus, the user may operate the widget menus using only the first to sixth sections.

When the user's finger is moved to the seventh section, the position detection apparatus may align the widgets so that the weather widget, i.e., the rightmost widget among the widgets, and the rightmost region of the weather widget correspond to the seventh section. Here, the widgets may be aligned at a position of the display screen corresponding to the second to seventh sections, and the user may operate the widget menus using the second to seventh sections.

Further, when the user's finger is moved to the eighth section, the position detection apparatus may align the widgets so that the weather widget, i.e., the rightmost widget among the widgets, and the rightmost region of the weather widget correspond to the eighth section. Here, the widgets may be aligned at a position of the display screen corresponding to the third to eighth sections, and the user may operate the widget menus using the third to eighth sections.

Further, when the user's finger is moved to the ninth section, the position detection apparatus may align the widgets so that the weather widget, i.e., the rightmost widget among the widgets, and the rightmost region of the weather widget correspond to the ninth section. Here, the widgets may be aligned at a position of the display screen corresponding to the fourth to ninth sections, and the user may operate the widget menus using the fourth to ninth sections.

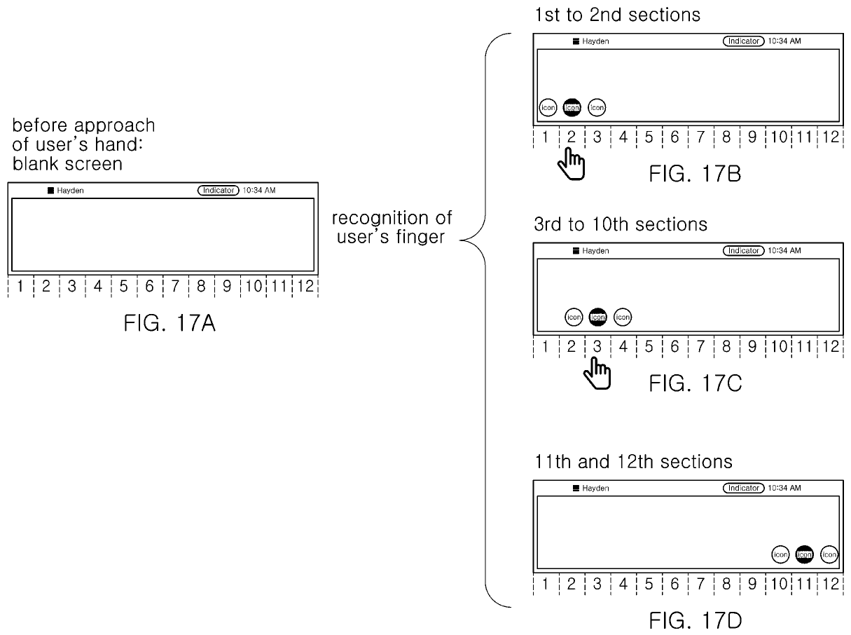

FIGS. 17A to 17D are views showing another example of the UI alignment method depending on the region, in which the object is first detected, in the position detection apparatus when the sensing field is divided into the twelve sections in the direction of the second axis.

Here, the position detection apparatus may display operable menus on the display screen using a plurality of icons rather than the plurality of widgets.

Referring to FIGS. 17A to 17D, the position detection apparatus may display a blank screen without menu icons before an object is detected, and may align a plurality of menu icons depending on a section in which a user's finger is first detected.

Here, when the user's finger is first detected in the first or second section, the position detection apparatus may align the plurality of menu icons on the left of the display screen, and may activate a menu icon located at a position corresponding to the user's finger.

For example, when the user's finger is first detected in the second section, the position detection apparatus may align the plurality of menu icons on the left of the display screen, and may activate a menu icon matching the second section among the plurality of menu icons.

Here, the corresponding menu icon may be activated in a way that the menu icon is enlarged, or has a different background color from other menu icons.

Further, when the user's finger is first detected in any of the third to tenth sections, the position detection apparatus may align the menu icons on the display screen such that a menu icon disposed at the center among the plurality of menu icons is located at a position corresponding to the user's finger, and may activate the menu icon located at the center.

For example, when the user's finger is first detected in the third section, the position detection apparatus may align the plurality of menu icons on the display screen such that the menu icon disposed at the center among the plurality of menu icons is located at a position corresponding to the third section, and may activate the menu icon matching the third section.

Further, when the user's finger is first detected in the eleventh or twelfth section, the position detection apparatus may align the plurality of menu icons on the right of the display screen, and may activate a menu icon located at a position corresponding to the user's finger.

For example, when the user's finger is first detected in the eleventh section, the position detection apparatus may align the plurality of menu icons on the right of the display screen, and may activate a menu icon matching the eleventh section among the plurality of menu icons.

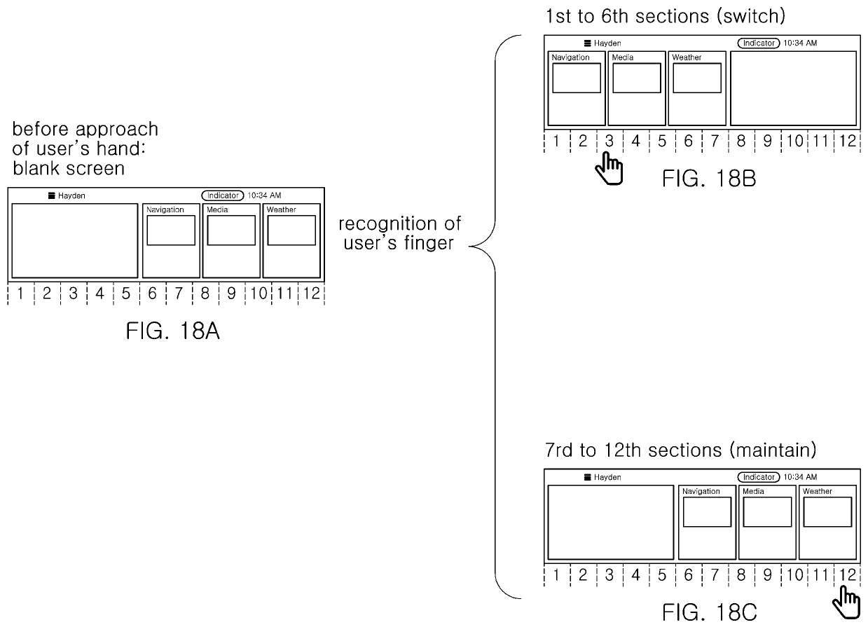

FIGS. 18A to 18C are views showing yet another example of the UI alignment method depending on the region, in which the object is first detected, in the position detection apparatus when the sensing field is divided into the twelve sections in the direction of the second axis.

Referring to FIGS. 18A to 18C, the position detection apparatus may display two screens, i.e., left and right screen, divided from each other, and particularly, may display a blank screen without menu icons as the left screen and may display a plurality of widgets on the right screen, before an object is detected.

Here, when a user's finger is first detected in any of the first to sixth sections, the position detection apparatus may switch the left and right screens, i.e., may shift the plurality of widget displayed on the right screen to the left screen, and may shift the blank screen displayed as the left screen to the right screen.

Further, when the user's finger is first detected in any of the seventh to twelfth sections, the position detection apparatus may maintain the state in which the blank screen is displayed as the left screen and the plurality of widgets is displayed on the right screen.

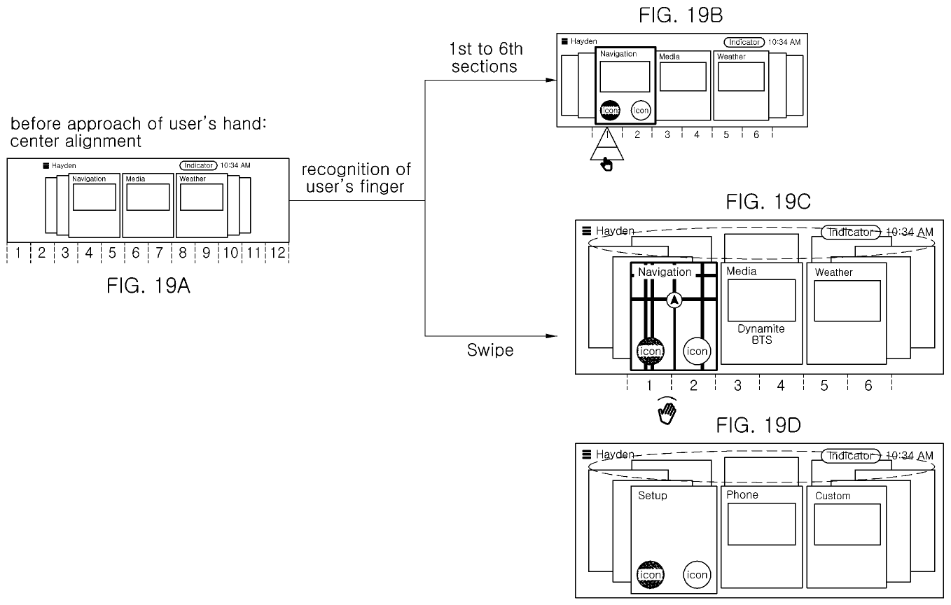

FIGS. 19A to 19D are views showing one example of a method of configuring a cylindrically converted menu in the position detection apparatus when the sensing field is divided into six sections in the direction of the second axis.

Referring to FIGS. 19A to 19D, the position detection apparatus according to one embodiment of the present invention may align a plurality of widgets in the deactivated state on the display screen before the position of an object is detected, and may activate a widget and a menu icon corresponding to a section in which a user's finger is first detected.

Here, when the user's finger is moved to another section in the direction of the second axis at a high speed, for example, when the user's finger or hand swipes from the first section to the second section, the position detection apparatus may rotate the widgets visualized in a cylinder so as to move some widgets currently displayed on the display screen to the rear surface of the cylinder and to move other widgets than the widgets currently displayed on the display screen to the front surface of the cylinder to display these widgets on the display screen.

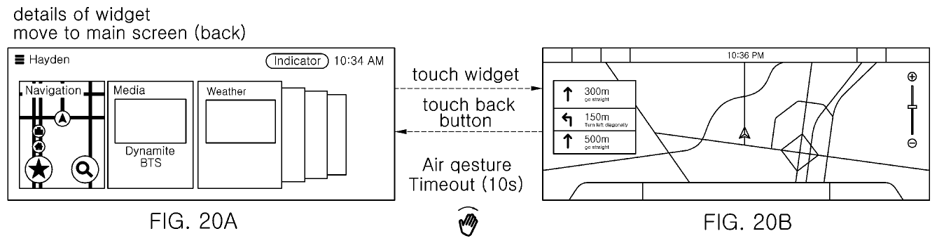

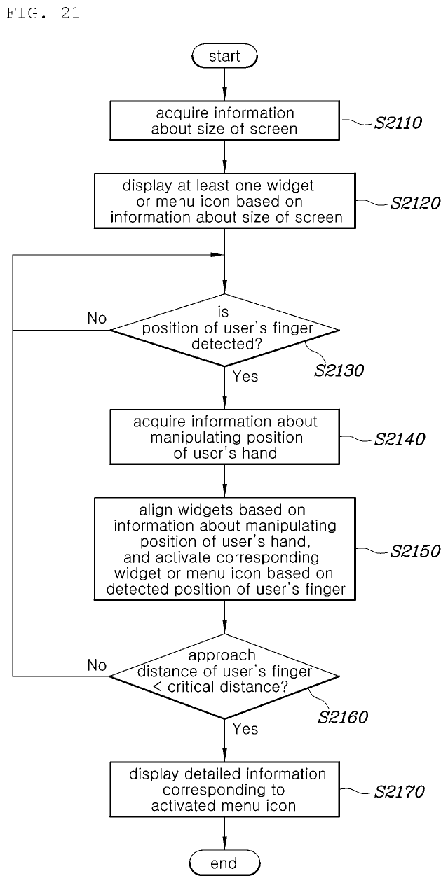

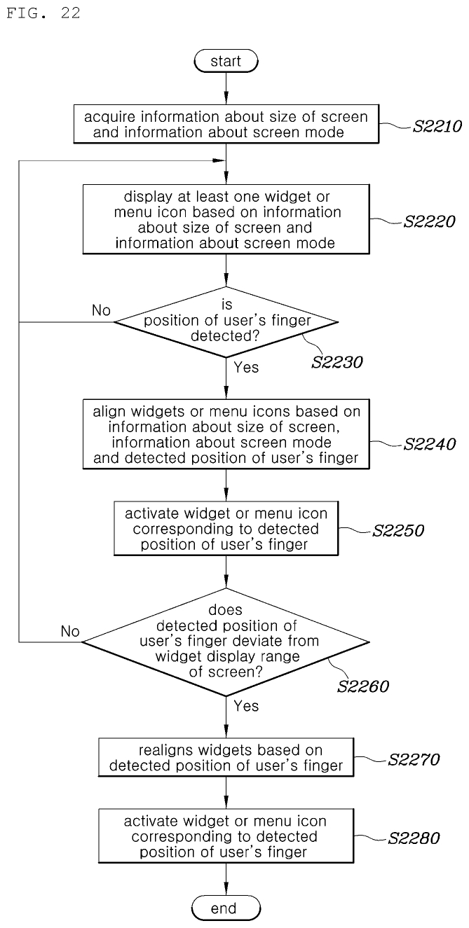

FIGS. 20A to 20B are views showing one example of conversion between an application execution screen and a main screen of the position detection apparatus according to one embodiment of the present invention.

Referring to FIGS. 20A to 20B, when a user touches the display screen of the position detection apparatus using a finger in the state in which a plurality of widgets is displayed on the display screen, a corresponding application may be executed.

Further, when the user touches a back button on the execution screen of the application or when the user's finger is moved from the left to the right of the screen in the state in which the user's finger is separated from the screen, i.e., when the user's finger or hand swipes from the first section to the second section, the display of the position detection apparatus may return to the previous screen.

FIG. 21 is a flowchart representing a display method using the position detection apparatus according to one embodiment of the present invention. Respective operations in FIG. 21 may be performed by a processor 150 of the position detection apparatus 100.

Referring to FIG. 21, the position detection apparatus 100 acquires information about the size of the screen thereof (S2110).

Here, the screen may have various sizes, for example, sizes corresponding to the sizes of the sensing field divided into six to twelve sections in the direction of the second axis.

Further, the position detection apparatus 100 displays at least one widget or menu icon based on the information about the size of the screen of the position detection apparatus 100 (S2120).

Here, the at least one widget or menu icon may be displayed on the center of the screen.

For example, the at least one widget may occupy six sections in the direction of the second axis based on the sensing field, each of three widgets may occupy two sections, and each of menu icons in one widget may occupy one section.

Here, when the sensing field is divided into six sections in the direction of the second axis so as to correspond to a small-sized screen, the at least one widget may be displayed to a length corresponding to the entirety of the six sections in one direction of the screen.

Further, when the sensing field is divided into eight sections in the direction of the second axis so as to correspond to a middle-sized screen, the at least one widget may be displayed to a length corresponding to the second to seventh sections in one direction of the screen.

Further, when the sensing field is divided into twelve sections in the direction of the second axis so as to correspond to a large-sized screen, the at least one widget may be displayed to a length corresponding to the fourth to ninth sections in one direction of the screen.

Here, all of the at least one widget or menu icon may be in the deactivated state on the screen, and may be aligned on the center of the screen.

Further, the position detection apparatus 100 determines whether or not the position of a user's finger is detected (S2130), and acquires information about the manipulating position of the user's hand upon determining that the position of the user's finger is detected (S2140).

Here, the manipulating position of the user's hand may be set in advance in the memory or the storage device, or may be determined based on the position of a section of the sensing area in which the user's finger is first detected. Further, the manipulating position of the user's hand may be determined based on the stretching direction of the detected user's hand or the shape of the hand.

Further, the position detection apparatus 100 aligns the widgets based on the information about the manipulating position of the user's hand, and activates a corresponding widget or menu icon based on the detected position of the user's finger (S2150).

For example, referring to FIGS. 6 to 8, in the position detection apparatus 100 in which the sensing field is divided into eight sections in the direction of the second axis, when the user's finger is first detected in the first section in the direction of the second axis, the position detection apparatus 100 may align the widgets, which have been aligned on the center of the screen, on the left of the screen, and may activate the navigation widget matching the first and second sections and the left icon matching the first section among the icons in the navigation widget, when the widgets are aligned on the left of the display screen.

Here, the corresponding widget or icon may be activated in a way that the widget or the icon is enlarged or has a different background color from other widgets or icons.

Further, when the user's finger is moved to the second section in the direction of the second axis in the state in which the user's finger remains in the far zone in the direction of the first axis, the position detection apparatus 100 may deactivate the left icon, which has been previously activated, in the navigation widget, and activate the right icon matching the second section among the icons in the navigation widget, thereby visually displaying movement of the position of the user's finger to the second section.

Moreover, when the user's finger is moved to the third section in the direction of the second axis in the state in which the user's finger remains in the far zone in the direction of the first axis, the position detection apparatus 100 may deactivate the navigation widget and the right icon, which have been previously activated, and may activate the media widget matching the third and fourth sections and the icon matching the third section among the icons in the media widget, thereby visually displaying movement of the position of the user's finger to the third section.

Further, the position detection apparatus 100 determines whether or not an approach distance of the user's finger to the screen is within a critical distance (S2160), and displays detailed information corresponding to the activated menu icon on the screen upon determining that the approach distance of the user's finger to the screen is within the critical distance (S2170).

For example, when the user's finger approaches the screen within the critical distance in the activated state of the left icon in the navigation widget, as shown in FIG. 6, icons indicating the detailed menu of the left icon may be displayed on the screen, as shown in FIG. 9.

FIG. 22 is a flowchart representing a display method using the position detection apparatus according to another embodiment of the present invention. Respective operations in FIG. 22 may be performed by the processor 150 of the position detection apparatus 100.

Referring to FIG. 22, the position detection apparatus 100 acquires information about the size of the screen thereof and information about a screen mode (S2210).

Here, the screen may have various sizes, for example, sizes corresponding to various sizes of the sensing field divided into six to twelve sections in the direction of the second axis.

Further, one of a full screen mode and a split screen mode may be used as the screen mode.

The information about the screen mode may be set in advance, and may be stored in the memory or the storage device of the position detection apparatus 100.

Further, the position detection apparatus 100 displays at least one widget or menu icon based on the information about the size of the screen of the position detection apparatus 100 and the information about the screen mode (S2220).

Here, the at least one widget or menu icon may be displayed on the center of the screen.

For example, the at least one widget may occupy six sections in the direction of the second axis based on the sensing field, each of three widgets may occupy two sections, and each of menu icons in one widget may occupy one section.

Here, when the sensing field is divided into six sections in the direction of the second axis so as to correspond to a small-sized screen, the at least one widget may be displayed to a length corresponding to the entirety of the six sections in one direction of the screen.

Further, when the sensing field is divided into eight sections in the direction of the second axis so as to correspond to a middle-sized screen, the at least one widget may be displayed to a length corresponding to the second to seventh sections in one direction of the screen.

Further, when the sensing field is divided into twelve sections in the direction of the second axis so as to correspond to a large-sized screen, the at least one widget may be displayed to a length corresponding to the fourth to ninth sections in one direction of the screen.

Here, all of the at least one widget or menu icon may be in the deactivated state on the screen, and may be aligned on the center of the screen in the full screen mode or aligned on the left screen in the split screen mode.

Further, the position detection apparatus 100 determines whether or not the position of a user's finger is detected (S2230), and aligns widgets or menu icons based on the size of the screen, the screen mode information, and the detected position of the user's finger upon determining that the position of the user's finger is detected (S2240).

For example, the position detection apparatus 100 may align the widgets or the menu icons based on the size of the screen, the screen mode information, and the detected position of the user's finger, as shown in FIG. 15, 17 or 18.

Further, the position detection apparatus 100 activates a widget or a menu icon corresponding to the detected position of the user's finger (S2250).

For example, the position detection apparatus 100 may activate the widget or the menu icon corresponding to the detected position of the user's finger, as shown in FIG. 15 or 17.

Further, the position detection apparatus 100 determines whether or not the detected position of the user's finger deviates from a widget display range of the screen (S2260), and realigns the widgets based on the detected position of the user's finger upon determining that the detected position of the user's finger deviates from a region corresponding to the widget display range of the screen (S2270).

For example, the position detection apparatus 100 may realign the widgets based on the detected position of the user's finger upon determining that the detected position of the user's finger deviates from the region corresponding to the widget display range of the screen, as shown in FIG. 16.

Further, the position detection apparatus 100 activates a menu icon corresponding to the detected position of the user's finger based on the positions of the widgets realigned in Operation S2270 (S2280).

According to the above-described embodiments of the present invention, a user may operate menus even from a long distance without stretching out his/her hand toward the display screen.

Further, the manipulating position and entry area of the user's hand and may be immediately reflected in the display screen.

In addition, the user may rapidly recognize the position of his/her finger measured by the apparatus, and may quickly select a desired menu item.

The present invention described above may be implemented as computer readable code in a computer readable recording medium in which programs are recorded. Computer readable recording media may include all kinds of recording media in which data readable by computer systems is stored. For example, the computer readable recording media may include a hard disk drive (HDD), a solid-state drive (SSD), a silicon disk drive (SDD), a ROM, a RAM, a CD-ROM, a magnetic tape, a floppy disk, an optical data storage device, etc.

As is apparent from the above description, in a position detection apparatus and a display method using the same according to various embodiments of the present invention, a user may operate menus even from a long distance without stretching out his/her hand toward a display screen.

Further, the manipulating position and entry area of the user's hand may be immediately reflected in the display screen.

In addition, the user may rapidly recognize the position of his/her finger measured by the apparatus, and may quickly select a desired menu item.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A display method using a position detection apparatus, comprising:
displaying, by a processor, at least one widget or menu icon to a length corresponding to at least a portion of an area of a display screen in one direction based on information about a size of the display screen;
aligning, by the processor, the at least one widget or menu icon based on a manipulating position of an object or a detected position of the object, in response to the object approaching the display screen; and
activating at least one of the at least one widget or menu icon based on the detected position of the object.

2. The display method according to claim 1, further comprising displaying, by the processor, detailed information corresponding to an activated menu icon on the display screen, in response to an approach distance of the object to the display screen being within a critical distance.

3. The display method according to claim 1, further comprising realigning, by the processor, the at least one widget based on the detected position of the object, in response to the object deviating from a region corresponding to a widget display range of the display screen.

4. The display method according to claim 1, wherein the manipulating position of the object is set in advance in a memory or a storage device, is determined based on a position at which the object is first detected, or is determined based on a stretching direction of the object or a shape of the object.

5. The display method according to claim 1, wherein, in the displaying of the at least one widget or menu icon, the at least one widget or menu icon is displayed based on the size of the display screen and information about a screen mode,
the size of the display screen is one of sizes corresponding to a small-sized screen, a middle-sized screen, and a large-sized screen, and
the screen mode is one of a full screen mode or a split screen mode.

6. A position detection apparatus comprising:
a display configured to display information on a display screen;
a linear infrared (IR) sensor configured to detect an object configured to approach the display; and
a processor configured to:
display at least one widget or menu icon to a length corresponding to at least a portion of an area of the display screen in one direction based on information about a size of the display screen,
align the at least one widget or menu icon based on a manipulating position of an object or a detected position of the object, when the object approaches the display screen, and
activate at least one of the at least one widget or menu icon based on the detected position of the object.

7. The position detection apparatus according to claim 6, wherein the processor displays detailed information corresponding to an activated menu icon on the display screen, when an approach distance of the object to the display screen is within a critical distance.

8. The position detection apparatus according to claim 6, wherein the processor realigns the at least one widget based on the detected position of the object, when the object deviates from a region corresponding to a widget display range of the display screen.

9. The position detection apparatus according to claim 6, wherein the manipulating position of the object is set in advance in a memory or a storage device, is determined based on a position at which the object is first detected, or is determined based on a stretching direction of the object or a shape of the object.

10. The position detection apparatus according to claim 6, wherein the processor displays the at least one widget or menu icon based on the size of the display screen and information about a screen mode,
the size of the display screen is one of sizes corresponding to a small-sized screen, a middle-sized screen, and a large-sized screen, and
the screen mode is one of a full screen mode or a split screen mode.
